(19) United States
(12) Patent Application Publication
(10) Pub. No.: US 2019/0289145 A1
(43) Pub. Date: Sep. 19, 2019

(54) IMAGE FORMING APPARATUS AND IMAGE FORMING METHOD

(71) Applicants: Kabushiki Kaisha Toshiba, Tokyo (JP); Toshiba Tec Kabushiki Kaisha, Tokyo (JP)

(72) Inventor: Masaya ARAKAWA, Hiratsuka Kanagawa (JP)

(73) Assignees: Kabushiki Kaisha Toshiba, Tokyo (JP); Toshiba Tec Kabushiki Kaisha, Tokyo (JP)

(21) Appl. No.: 15/923,663

(22) Filed: Mar. 16, 2018

(51) Int. Cl. H04N 1/00; G06F 3/12

(52) U.S. Cl. CPC H04N 1/00376; G06F 3/1257; G06F 3/1205

(57) ABSTRACT

An exposure device includes a predetermined number of light emitting elements. A sheet setting unit accepts a user setting of the sheet on which the image is to be formed. The sheet on which the image is to be formed includes at least a first sheet and a second sheet different from the first sheet. The first sheet is a maximum sheet which can be used by the image forming apparatus. A controller determines a width of a margin based on the user setting of the sheet on which the image is to be formed. The margin is a region provided on each of both sides of the direction orthogonal to the sheet and on which the image is not formed. The controller forms the image on the sheet set by the user by controlling the exposure device according to the determined margin width.

### FIELD

Embodiments described herein relate generally to an image forming apparatus and an image forming method.

### BACKGROUND

The image forming apparatus forms an image on a sheet. The image forming apparatus generally forms a latent image on a photoconductor by irradiating the photoconductor with image light. The image forming apparatus obtains a visible image by visualizing the latent image with a developing material (developer). The image forming apparatus moves the visible image on the sheet. Alternatively, the image forming apparatus moves the visible image on an intermediate transfer belt first, then the image forming apparatus moves the visible image moved on the intermediate transfer belt on the sheet again. The image forming apparatus fixes the visible image moved on the sheet on the sheet by a fixing device.

Various methods for irradiating the photoconductor with the image light are known. For example, there is an image forming apparatus using a liquid emitting diode (LED) head. The LED head has a predetermined number of LED elements arranged in a linear shape. In the LED head, the predetermined number of the LED elements are arranged in an extended state in a main-scanning direction orthogonal to a sub-scanning direction, the latter of which is a sheet transport direction. According to this arrangement, the image in a linear shape is formed on the sheet in the main-scanning direction. Subsequently, the sheet is transported in the sub-scanning direction by a determined interval corresponding to resolution. The images in the linear shape which are extended in the main-scanning direction are formed in order by repeating image formation in the main-scanning direction and sheet transport in the sub-scanning direction on the sheet. The image forming apparatus using the LED head forms an output image determined by the number of pixels (the number of the LED elements) in the main-scanning direction and the number of the images in the sub-scanning direction.

The number of the LED elements in the LED head is determined by the resolution and a sheet width obtained from a maximum sheet used by the image forming apparatus. A width of the image, which can be formed in the main-scanning direction, is called an effective writing width. That is, the effective writing width is defined by the predetermined number of the LED elements. The effective writing width is the same as the sheet width of the maximum sheet used by the image forming apparatus or may be equal to or longer than the sheet width.

The image forming apparatus includes a copying apparatus, a printing apparatus, and a multi-function peripheral (hereinafter, abbreviated to “MFP”) which has both functions of the copying apparatus and the printing apparatus.

There is a case where a width in the sub-scanning direction of the latent image formed on the photoconductor is longer than the sheet width of the sheet on which the image is formed. In this case, in the photoconductor or the intermediate transfer belt, the visible image of the latent image formed on a portion larger than the sheet width remains without being moved to the sheet. That is, the photoconductor or the intermediate transfer belt is contaminated. For this reason, the copying apparatus adopts the LED head with the effective writing width having margins of approximately 2.0 mm on each of both sides of the sheet width of the maximum sheet.

Industry standards of the printing apparatus provide for margins of 4.2 mm to an entire circumference of the sheet. Therefore, the effective writing width of the printing apparatus is the sheet width of the maximum sheet—4.2*2 mm.

For this reason, the MFP generally uses the LED head with the effective writing width respectively having margins of 4.2 mm on both sides in the sub-scanning direction based on the printing apparatus. If the LED head is used, the shorter the effective writing width, the smaller the number of the LED elements can be. Therefore, adopting such a margin width of 4.2 mm leads to cost reduction of the LED head.

The margin width of 4.2 mm in the MFP is constant regardless of a size of the sheet. That is, even if the sheet of a size smaller than a size of the maximum sheet is used, the margin width is 4.2 mm. For example, in one case an image is formed with the margin width of 2.0 mm by another copying apparatus with respect to the sheet having a size smaller than the maximum sheet can be used by the MFP is to be copied by the MFP. In this case, in the MFP, only an image with missing images of 4.2 mm−2.0 mm=2.2 mm on each of both sides in the sub-scanning direction can be formed on the sheet even though the image is written without exception.

In addition, there is also a case where a user does not use the sheet of the maximum sheet size of the MFP.

Therefore, an image forming apparatus capable of changing the margin width is required.

### DESCRIPTION OF THE DRAWINGS

FIG. 1 is a mechanical configuration diagram illustrating an example of an image forming apparatus according to an embodiment.

FIG. 2 is a perspective view of an image forming unit.

FIG. 3 is a block diagram illustrating an electrical configuration.

FIG. 4 is a diagram illustrating a relationship between an exposure device and a sheet.

FIG. 5 is a diagram illustrating an example of a sheet table configured in a non-volatile memory (NVM).

FIG. 6 is a diagram illustrating an example of a temporary sheet table configured in a random-access memory (RAM).

FIG. 7 is a flowchart illustrating an example of an operation unit input process.

FIG. 8A is a diagram illustrating a display example of a display unit during the operation unit input process.

FIG. 8B is a diagram illustrating another display example of the display unit.

FIG. 8C is a diagram illustrating still another display example of the display unit.

FIG. 8D is a diagram illustrating still another display example of the display unit.

FIG. 9 is a flowchart illustrating an example of a printing process subroutine.

FIG. 10 is a diagram illustrating a display example of the display unit during the printing process.

### DETAILED DESCRIPTION

In general, according to one embodiment, there is provided an image forming apparatus which forms an image on a sheet. The image forming apparatus includes an exposure device, a sheet setting unit, and a controller. The exposure device includes a predetermined number of light emitting elements arranged in a linear shape in a direction orthogonal to a sheet transport direction of the sheet on which the image is to be formed. The sheet setting unit accepts a user setting of the sheet on which the image is to be formed. The sheet on which the image is to be formed includes at least a first sheet and a second sheet different from the first sheet. The first sheet is a maximum sheet which can be used by the image forming apparatus. The controller controls the exposure device. Specifically, the controller determines a width of a margin based on the user setting of the sheet on which the image is to be formed. The margin is a region provided on each of both sides of the direction orthogonal to the sheet and on which the image is not formed. By controlling the exposure device according to the determined margin width, the controller forms the image on the sheet set by the user.

Hereinafter, the embodiments will be described with reference to drawings.

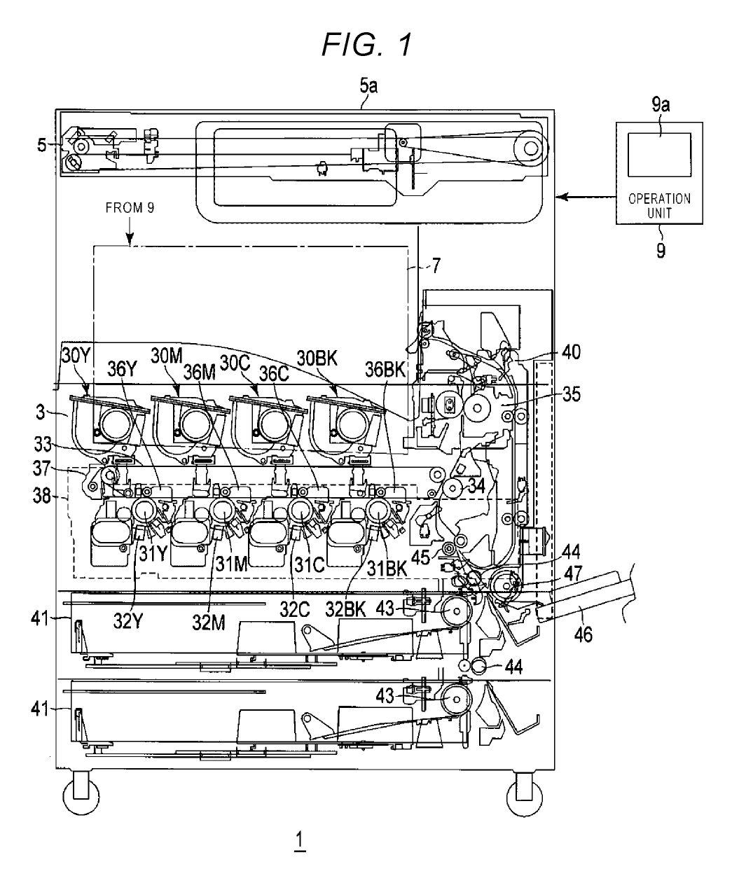

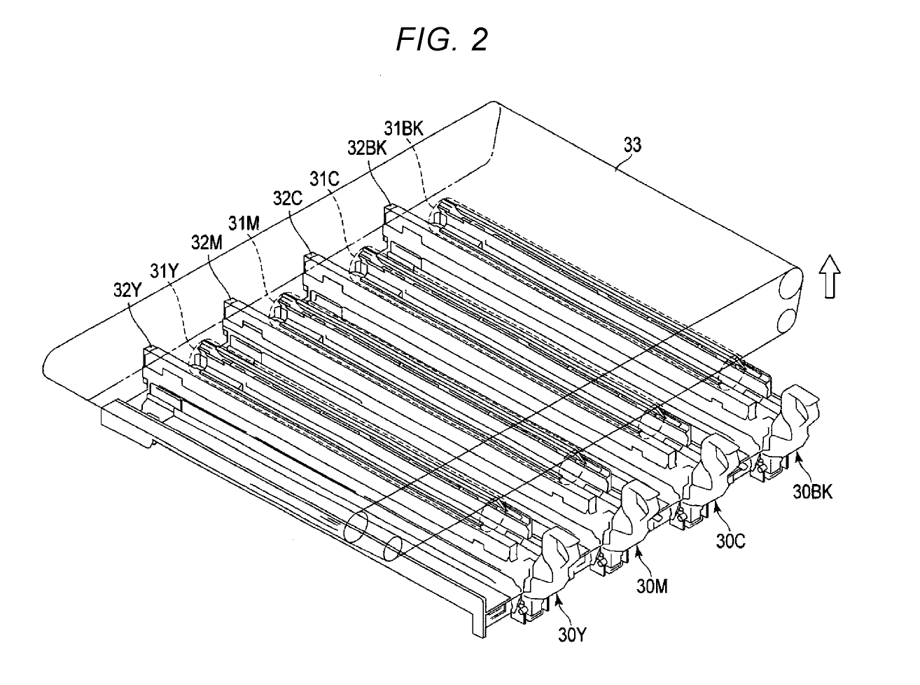

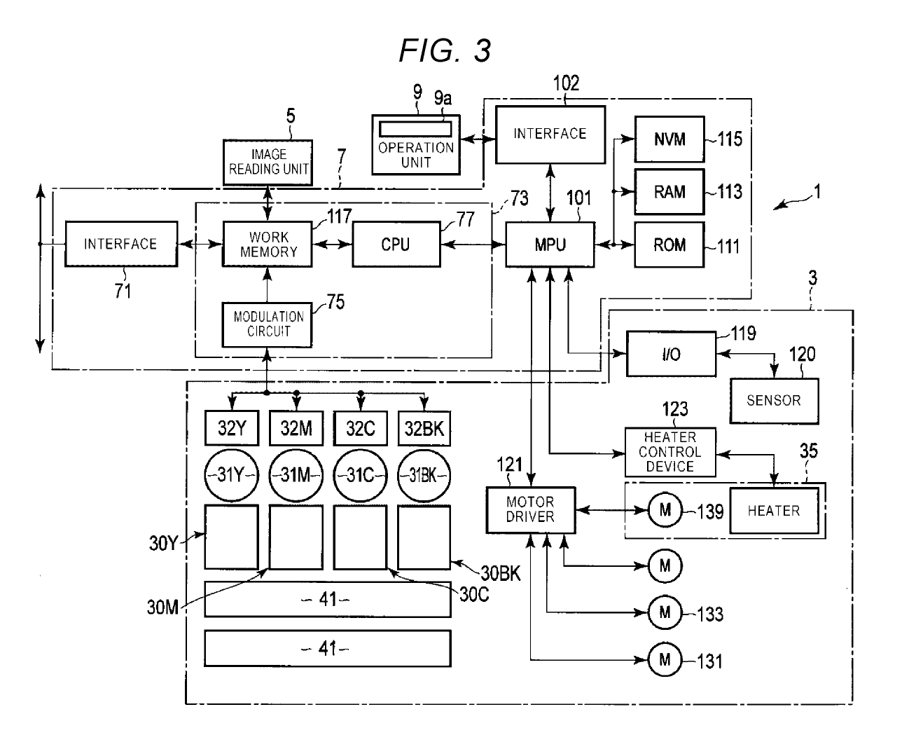

FIG. 1 is a mechanical configuration diagram illustrating an example of the image forming apparatus according to the embodiment, FIG. 2 is a perspective view of an image forming unit included in the image forming apparatus, and FIG. 3 is a block diagram illustrating an electrical configuration of the image forming apparatus.

The image forming apparatus of the embodiment is a multi-function apparatus (hereinafter, referred to as “MFP”) 1 having both functions of a copying apparatus and a printing apparatus. The MFP 1 may further have a function of a facsimile apparatus.

The MFP 1 includes at least an image forming unit 3, an image reading unit 5, and a signal process and an operation controller (circuit substrate unit) 7. An operation unit (display panel) 9 is provided in a predetermined position of the MFP1.

The image forming unit 3 forms a visible image corresponding to image data on a sheet, which is paper or a resin sheet. For example, the image data may be data generated by the image reading unit 5 or may be external data. The external data may be data provided by a storage (portable) medium such as a semiconductor memory or may be data provided by a supply source on the network via an interface 71.

The image reading unit 5 captures characters, illustrations, photographs, or the like on an object to be read as gradations of light and shade and generates an image data corresponding to those gradations of light and shade.

The image reading unit 5 includes at least an original document table (original document glass) 5a, a lighting device, and an image sensor. The lighting device irradiates with illumination light an original document (target to be read) supported by the original document table 5a. The image sensor receives reflected light (image information) reflected by the original document and generates an image signal by photo-electric conversion. The image sensor is, for example, a CCD sensor or a complementary metal-oxide semiconductor (CMOS) sensor.

The signal process and operation controller 7 causes the image forming unit 3 to convert the image signal generated by the image reading unit 5 into image data appropriate for image formation. The signal process and operation controller 7 performs a predetermined process on the image signal from the image sensor. The predetermined process includes, for example, character identification, contour correction, color-tone correction (color conversion, RGB→CMY, density), half-tone (gradation), γ characteristic (input density value to output density value) , and the like for an output image (print out). The image signal and the image data are stored in a storage device (not illustrated) such as a hard disk drive (HDD). In addition, the image signal and the image data can be read from the MFP 1 and can be stored in a semiconductor memory (not illustrated).

The image forming unit 3 includes first to fourth single color image forming stations (visible image forming units) 30Y, 30M, 30C, and 30BK and first to fourth exposure devices 32Y, 32M, 32C, and 32BK. The single color image forming stations 30Y, 30M, 30C, and 30BK, respectively, have photoconductive drums (image carriers) 31Y, 31M, 31C, and 31BK, developing devices, and transfer devices (primary transfer units). The photoconductive drums 31Y, 31M, 31C, and 31BK generate and hold latent images corresponding to exposure light, that is, image light from the exposure devices 32Y, 32M, 32C, and 32BK.

The image forming unit 3 further includes an intermediate transfer belt (visible image holding (primary transfer) unit) 33, a sheet transfer device (secondary transfer unit) 34, a fixing device 35, first to fourth waste toner collection mechanisms 36Y, 36M, 36C, and 36BK, an intermediate transfer belt cleaner 37, a waste toner collection device 38, and the like.

In each of the single color image forming stations (visible image forming units) 30Y, 30M, 30C, and 30BK, each of the first to fourth exposure devices 32Y, 32M, 32C, and 32BK irradiates each of the photoconductive drums 31Y, 31M, 31C, and 31BK with the exposure light, that is, the image light.

A potential held by each of the photoconductive drums 31Y, 31M, 31C, and 31BK changes according to intensity of the image light.

The image forming unit 3 further includes an automatically duplex unit (hereinafter, abbreviated to “ADU”) 40, at least one paper feed cassette 41, a paper feed mechanism 43 attached to each of paper feed cassettes, a transport mechanism 44, and an aligning mechanism 45. The MFP 1 of the embodiment has two paper feed cassettes 41. A manual feed tray 46 and a paper feed mechanism 47 attached to the manual feed tray 46 are provided on a former stage of the aligning mechanism 45. In addition, the paper feed cassette 41 can be used by being stacked in a plurality of stages.

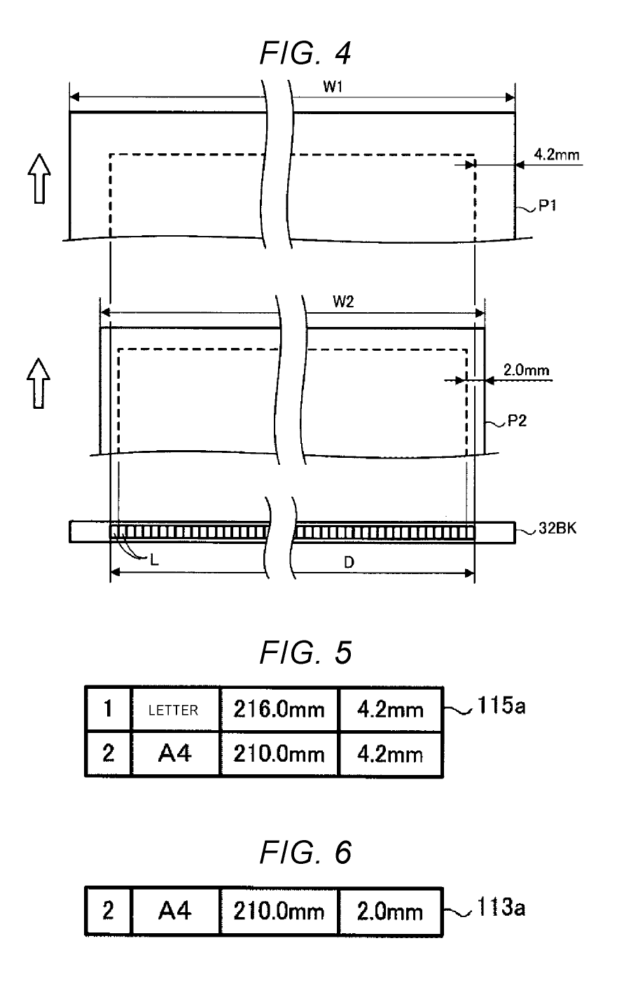

FIG. 4 is a diagram illustrating a relationship between an exposure device and a sheet in the MFP 1. Since the first to fourth exposure devices 32Y, 32M, 32C, and 32BK have the same configuration, only the fourth exposure device 32BK is representatively illustrated in FIG. 4. Each of the exposure devices 32Y, 32M, 32C, and 32BK includes an LED head. The LED head has a predetermined number of LED elements L arranged in the linear shape. In each of the exposure devices 32Y, 32M, 32C, and 32BK, the predetermined number of the LED elements L are arranged in an extended state in a main-scanning direction orthogonal to a sub-scanning direction, the latter of which is a sheet transport direction. In FIGS. 2 and 4, the sheet transport direction is indicated by outline arrows.

The predetermined number of the LED elements L in each of the exposure devices 32Y, 32M, 32C, and 32BK is determined by resolution, a size of a maximum sheet which can be used by the MFP 1 in the main-scanning direction, and a predetermined margin width. In FIG. 4, the maximum sheet which can be used by the MFP 1 is a first sheet P1, a size of the first sheet P1 in the main-scanning direction is a first sheet width W1, and the predetermined margin width is 4.2 mm. A length of a row of the LED elements L determined in this manner (i.e., an effective writing width D) is a width of an image which can be formed in the main-scanning direction. That is, in the first sheet P1, which is the maximum sheet, a first margin width of 4.2 mm remains on each of both sides of the first sheet P1 in the main-scanning direction and the image can be formed. Although a margin width of the sheet in the sub-scanning direction is arbitrarily determined, the same margin width as the margin of the sheet in the main-scanning direction is generally used.

In the exposure devices 32Y, 32M, 32C, and 32BK having such a configuration, a second sheet P2, having a second sheet width W2 shorter than the first sheet width W1 of the first sheet P1, may adopt not only the first margin width of 4.2 mm, but also a second margin width which is different from the first margin width. For example, the second margin width may be shorter than the first margin width (e.g., the second margin width may be 2.0 mm).

The first to fourth exposure devices 32Y, 32M, 32C, and 32BK output the image light. The image light is obtained by converting the image data from an image process unit 73 (FIG. 3) of the signal process and operation controller 7 into light intensity. The image light output by the first to fourth exposure devices 32Y, 32M, 32C, and 32BK, respectively, forms a latent image on the photoconductive drums 31Y, 31M, 31C, and 31BK of the first to fourth single color image forming stations 30Y, 30M, 30C, and 30BK. That is, the potential of the photoconductive drums 31Y, 31M, 31C, and 31BK of the single color image forming stations 30Y, 30M, 30C, and 30BK changes according to the intensity of the image light from the LED head and a potential difference is the latent image (electrostatic image).

The single color image forming stations 30Y, 30M, 30C, and 30BK form visible images of colors of Y (yellow), M (magenta), C (cyan), and BK (black), respectively. The developing device visualizes, that is, develops the image by supplying a toner to the above-described latent image held by each of the photoconductive drums 31Y, 31M, 31C, and 31BK. The transfer device moves a toner image (visible image) held by each of the photoconductive drums 31Y, 31M, 31C, and 31BK to the intermediate transfer belt 33. An arrangement (position) of each of the single color image forming stations 30Y, 30M, 30C, and 30BK, that is, the order of colors is determined according to an image forming process or toner characteristics.

The intermediate transfer belt 33 holds the toner image formed by each of the single color image forming stations 30Y, 30M, 30C, and 30BK and transports the toner image in a sheet direction. The sheet transfer device 34 moves the toner image transported by the intermediate transfer belt 33 to the sheet. The fixing device 35 fixes the toner, that is, the toner image moved from the intermediate transfer belt 33 to the sheet by the sheet transfer device 34 to the sheet.

The first to fourth waste toner collection mechanisms 36Y, 36M, 36C, and 36BK respectively collect a transfer-remaining toner (surplus toner) in a periphery of the transfer device (primary transfer unit) of each of the single color image forming stations 30Y, 30M, 30C, and 30BK. The transfer-remaining toner is the surplus toner remaining (on each of the photoconductive drums) without being moved from the photoconductive drum to the intermediate transfer belt 33. The transfer-remaining toner is removed from each of the photoconductive drums by a cleaner (not illustrated) included in each of the waste toner collection mechanisms 36Y, 36M, 36C, and 36BK.

The intermediate transfer belt cleaner 37 collects a transfer-remaining (surplus) toner remaining on the intermediate transfer belt 33 without being moved from the intermediate transfer belt 33 to the sheet in a periphery of the sheet transfer device (secondary transfer unit) 34.

The waste toner collection device 38 collects the transfer-remaining toner collected by the waste toner collection mechanisms 36Y, 36M, 36C, and 36BK and the transfer-remaining toner collected by the intermediate transfer belt cleaner 37.

The paper feed mechanism. 43 pulls out the sheet from. the paper feed cassette 41 at a predetermined timing corresponding to image forming operation in each of the single color image forming stations 30Y, 30M, 30C, and 30BK. The transport mechanism 44 moves the sheet pulled out to a transfer position in contact with the intermediate transfer belt 33 and the sheet transfer device 34. The aligning mechanism 45 sets a timing at which the sheet is moved to the transfer position for the image forming operation in each of the single color image forming stations 30Y, 30M, 30C, and 30BK.

The fixing device 35 heats the sheet and the toner electrostatically adhered to the sheet and applies pressure to the sheet and the toner. Accordingly, the toner is fixed on the sheet. The sheet on which the toner (toner image) fixed by the fixing device 35 is held, is moved to a space between the image reading unit 5 and the image forming unit 3 or the ADU (automatically duplex unit) 40 as an output image (print out).

The ADU 40 inverts a front and back of the sheet so that the toner can be moved to a second side, with the second side being a back side of a first side of the sheet on which the toner image is closely attached to the first side. The ADU 40 moves (places) the inverted sheet to the aligning mechanism 45.

As illustrated in an example of FIG. 3, the signal process and operation controller 7 includes the image input unit (interface) 71, the image process unit 73, and the like. The image process unit 73 includes a modulation circuit (exposure light signal generation unit) 75, a CPU 77, and the like.

The interface 71 receives image data supplied from an external device such as a personal computer (PC) via the network or the like.

The image process unit 73 performs a predetermined process on the character identification, the contour correction, the color-tone correction, the y characteristic, and the like of the image signal generated by the image reading unit 5 or the image data from the interface 71. The exposure light signal generation unit 75 converts the image data on which the predetermined process is performed, into a modulation signal (exposure light signal) for exposure light used by the first to fourth exposure devices 32Y, 32M, 32C, and 32BK.

The CPU 77 controls a process of the image data in the image process unit 73.

The signal process and operation controller 7 further includes the image process unit 73 (CPU 77), the image forming unit 3, the image reading unit 5, and a main control device (hereinafter, referred to as “MPU”) 101 which controls overall operation of the MFP 1. The MPU 101 controls image reading operation, image forming operation, and the like in the MFP 1.

The MPU 101 receives a control input from the operation unit 9 which receives an instruction (operation) input for the MFP 1 via an interface 102. The MPU 101 controls each of units (elements) of the MFP 1 according to the control input from the operation unit 9.

The operation unit 9 has a display unit 9a. The display unit 9a displays a state or the like of each of the units of the MFP1 by a display (user interface) known as, for example, a character string or symbol (pictogram/icon) or the like. The display unit 9a further functions as a touch panel. If the display unit 9a receives instruction (control) input from the user, the display unit 9a displays the received input.

The signal process and operation controller 7 also includes a ROM (program memory) 111, a RAM 113, a non-volatile memory (NVM) 115, a page memory (work memory) 117 used for the image process in the image process unit 73, and the like.

FIG. 5 is a diagram illustrating an example of a sheet table 115a configured in the NVM 115. The sheet table 115a is a table in which a cassette number, a sheet type, a sheet width W, and a margin width for each of the paper feed cassettes 41 are associated with one another. The sheet size set for each of the paper feed cassettes 41 and the margin width may be set to have a default value. Both of the sheet size of each of the paper feed cassettes 41 and the margin width corresponding to each of the paper feed cassettes 41 may be set by operating the operation unit 9. That is, since the most frequently used sheet size and margin width are determined depending on the user's use state, the settings for each are configured according to the user's request. However, the margin of the sheet of the maximum size which can be used by the MFP 1 cannot be set except for the first margin width of 4.2 mm. In a second paper feed cassette 41 different from the first paper feed cassette 41, a sheet size is the same as the sheet size of the first paper feed cassette 41, but a sheet having a different thickness can be accommodated and a margin can be set to each of the first and second paper feed cassettes 41.

Since the MFP 1 illustrated in FIG. 1 has only two stages of the paper feed cassettes 41, in an example of the sheet table 115a of FIG. 5, there are two records. As the number of stages of the paper feed cassettes 41 increases, the number of records of the sheet table 115a also increases accordingly. In addition, if the MFP 1 has a configuration in which each of the paper feed cassettes 41 is distinguished with one another by the sensor, it is also possible to increase the number of records, in which the cassette number, the sheet type, the sheet width W, and the margin width are set in the same manner, for a preliminary paper feed cassette 41 not attached to the MFP 1.

In addition, in order to deal with use of the manual feed tray 46, another sheet table in which a margin width for each of sheet sizes is set may be configured in the NVM 115.

FIG. 6 is a diagram illustrating an example of a temporary sheet table 113a configured in the RAM 113 . The temporary sheet table 113a is a table in which the cassette number, the sheet type, the sheet width W, and the margin width for the paper feed cassettes 41, set according to operation of the operation unit 9 of the user, are associated with one another.

The MPU 101 is connected to a motor driver 121 for controlling rotation of preliminary determined motors 131, 133, etc. through 139 provided in the image forming unit 3. The motor 131 drives, for example, the first to fourth single color image forming stations 30Y, 30M, 30C, and 30BK and the intermediate transfer belt 33. The motor 133 drives, for example, the paper feed mechanism. 43, the transport mechanism 44, the aligning mechanism 45, and the sheet transfer device 34 which are elements between the paper feed cassette 41 related to transport of the sheet and the fixing device 35 (ADU 40). The motor 139 independently drives, for example, the fixing device 35.

The MPU 101 is also connected to a heater control device 123 which drives a heater for setting a temperature of the fixing device 35.

The MPU 101 is further connected to an I/O port 119. An output and the like from a sensor 120 provided in each of parts of the image forming unit 3 is input via the I/O port 119.

Hereinafter, operation of the MFP 1 will be described. Furthermore, contents of the process to be described below is one example, the various processes can be appropriately utilized so as to achieve same results.

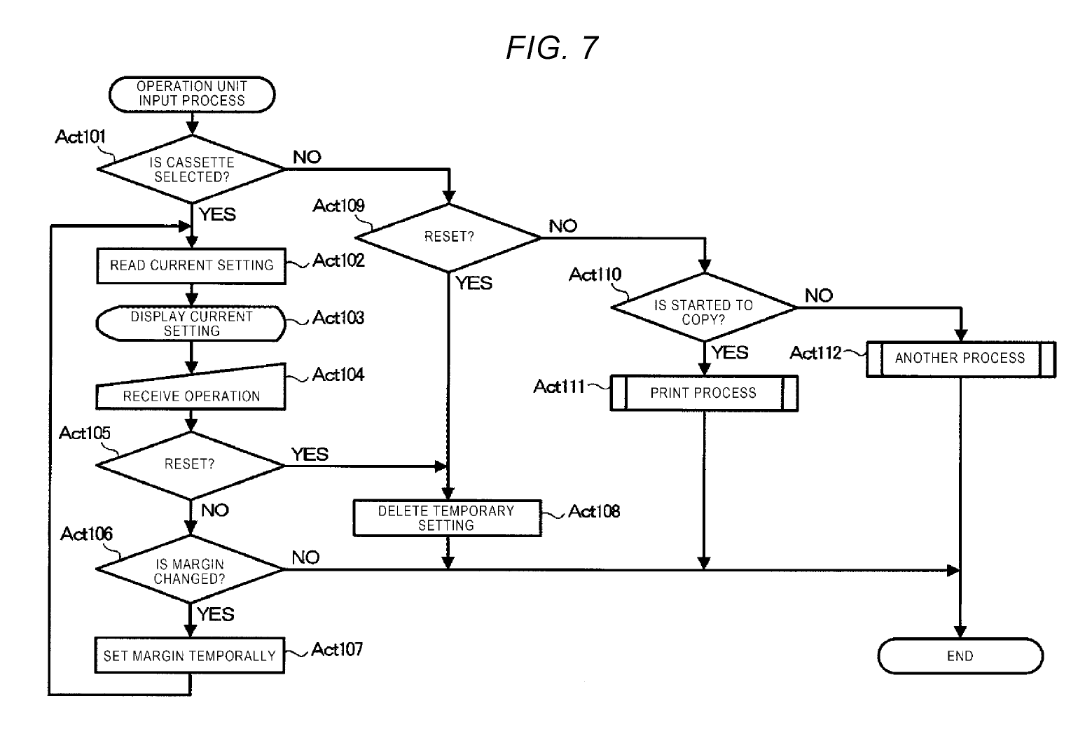

FIG. 7 is a flowchart illustrating an example of an operation unit input process executed by the MPU 101. The control process illustrated in this flowchart is executed according to operation of the operation unit 9 by the user. That is, if the control input is input from the operation unit 9 via the interface 102, the MPU 101 starts to perform the control process illustrated in FIG. 7 according to a control program stored in the ROM 111.

If the control input is input from the operation unit 9 via the interface 102, the MPU 101 determines whether or not the user selects operation of the paper feed cassette 41 (Act 101). If it is determined that the user selects operation of the paper feed cassette 41 (YES in Act 101), the MPU 101 reads a current setting for the selected paper feed cassette 41 (Act 102). Reading the current setting is performed as follows. Firstly, the MPU 101 checks the temporary sheet table 113a of the RAM 113. If the setting for the selected paper feed cassette 41 is stored in the temporary sheet table 113a, the MPU 101 reads the setting. If the setting for the selected paper feed cassette 41 is not stored in the temporary sheet table 113a, the MPU 101 reads the setting for the selected paper feed cassette 41 from the sheet table 115a of the NVM 115.

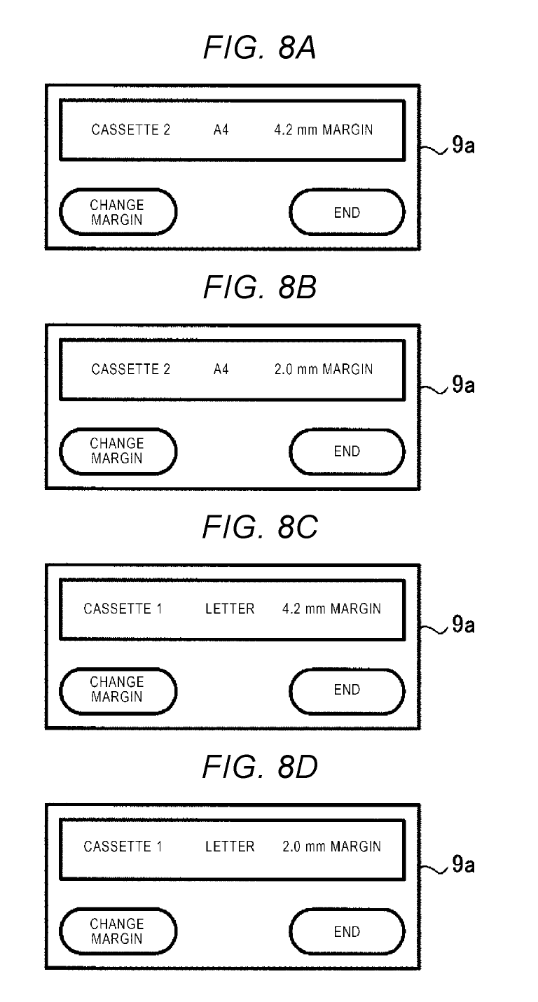

Then, the MPU 101 displays current setting contents read from the sheet table 115a on the display unit 9a of the operation unit 9 via the interface 102 (Act 103). For example, FIG. 8A illustrates a display example of the display unit 9a when the paper feed cassette 41 of the cassette number 2 is selected and nothing is stored in the temporary sheet table 113a of the RAM 113. The MPU 101 then accepts operation of the operation unit 9 by the user (Act 104).

If the control input is input from the operation unit 9 via the interface 102, the MPU 101 determines whether or not the control input is press operation of a reset button (not illustrated) provided in the operation unit 9 (Act 105).

If it is determined that the control input is not press operation of the reset button (NO in Act 105), the MPU 101 further determines whether or not the control input from the operation unit 9 is a user touch operation corresponding to an icon of “change margin” displayed on the display unit 9a (Act 106). If it is determined that the control input is the user touch operation corresponding to the icon of “change margin” (YES in Act 106), the MPU 101 temporally stores the changed margin in the temporary sheet table 113a of the RAM 113 (Act 107). For example, after the MPU 101 copies the current setting for the paper feed cassette 41 stored in the sheet table 115a of the NVM 115 to the temporary sheet table 113a, the MPU 101 changes the margin width in the temporary sheet table 113a. That is, if the copied margin width is 4.2 mm, the margin width is changed to 2.0 mm, and if the copied margin width is 2.0 mm, the margin width is changed to 4.2 mm. According to an example illustrated in FIG. 8A, the sheet width of the paper feed cassette 41 of the cassette number 2 is changed from 4.2 mm to 2.0 mm. Accordingly, the temporary sheet table 113a has storage contents illustrated in FIG. 6.

Subsequently, the control process is returned to the Act 102, and the MPU 101 reads the current setting for the selected paper feed cassette 41 from the temporary sheet table 113a or the sheet table 115a. In this case, since a setting of the changed margin width is stored in the temporary sheet table 113a, the MPU 101 reads the setting as illustrated in FIG. 6. Therefore, FIG. 8B illustrates a display of setting contents displayed by the display unit 9a in the next Act 103.

On the other hand, if it is determined that the control input is not the user touch operation according to the icon of “change margin” in the Act 106 (NO in Act 106), the MPU 101 determines that the control input from the operation unit 9 is user touch operation corresponding to an icon of “end” displayed on the display unit 9a and ends the operation unit input process.

In addition, if it is determined that the control input is the press operation of the reset button in the Act 105 (YES in Act 105), the MPU 101 deletes the contents of the temporary sheet table 113a of the RAM 113, that is, the temporary setting of the margin (Act 108). After that, the MPU 101 ends the operation unit input process.

In addition, if it is determined that the user does not select operation of the paper feed cassette 41 in the Act 101 (NO in Act 101), the MPU 101 determines whether or not the control input from the operation unit 9 via the interface 102 is the press operation of the reset button (Act 109). In addition, if it is determined that the control input is the press operation of the reset button (YES in Act 109), the control process is moved to the Act 108 and the MPU 101 deletes the contents of the temporary sheet table 113a of the RAM 113, that is, the temporary setting of the margin.

If it is determined that the user does not select the press operation of the reset button in the Act 109 (NO in Act 109), the MPU 101 determines whether or not the control input is press operation of a copy start button (not illustrated) provided in the operation unit 9 (Act 110). If it is determined that the control input is the press operation of the copy start button (YES in Act 110), the MPU 101 performs image formation, that is, print on the sheet of the selected paper feed cassette 41 by executing a printing process subroutine (Act 111). After then, the MPU 101 ends the operation unit input process.

In addition, if it is determined that the control input is not the press operation of the copy start button in the Act 110 (NO in Act 110), the MPU 101 executes a process according to the control input which is not the press operation (Act 112). After, the MPU 101 ends the operation unit input process.

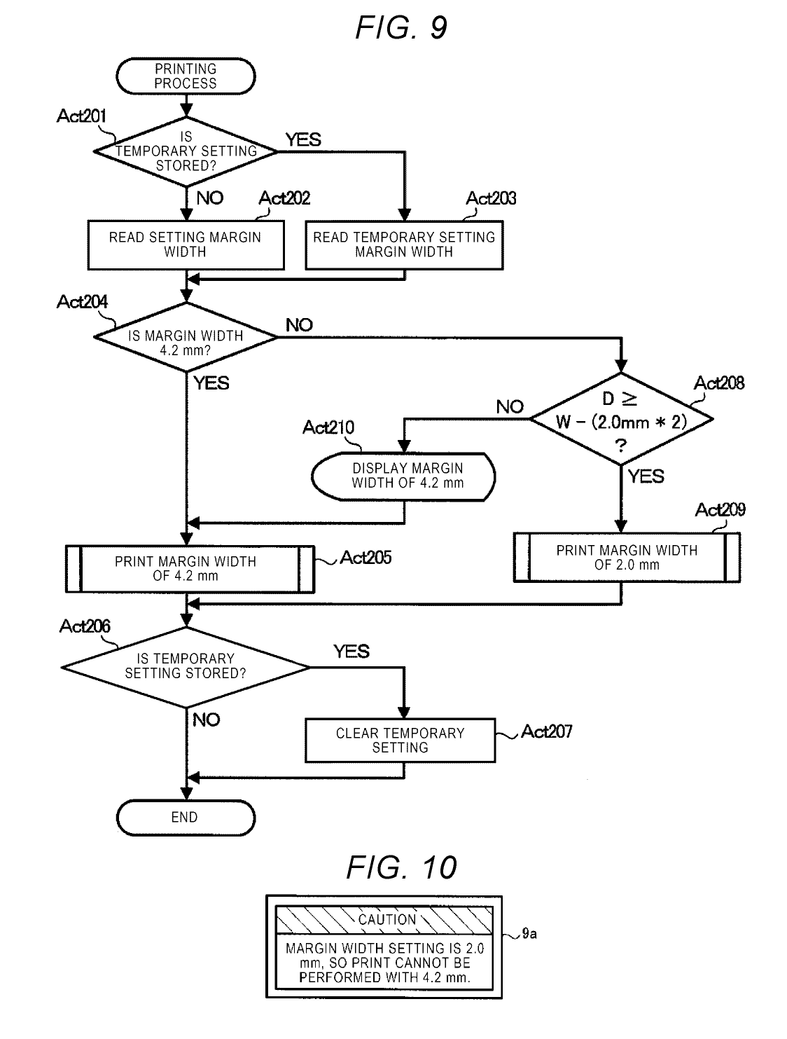

As illustrated in FIG. 8C, even if the paper feed cassette 41 of the cassette number 1 corresponding to the first sheet which is the maximum sheet size is selected, the margin width can be changed from 4.2 mm to 2.0 mm by the touch operation of the icon of “change margin” as illustrated in FIG. 8D. However, the effective writing width D corresponds to the margin width of 4.2 mm, so that the image cannot be formed on the first sheet using the margin width of 2.0 mm. For this reason, the MPU 101 executes the printing process subroutine illustrated in FIG. 9 in the Act 111.

Firstly, the MPU 101 determines whether or not a temporary setting having the margin width is stored in the temporary sheet table 113a of the RAM 113 (Act 201). If it is determined that the temporary setting having the margin width is not stored in the temporary sheet table 113a (NO in Act 201), the MPU 101 reads the setting having the margin width from the sheet table 115a of the NVM 115 (Act 202). In addition, if it is determined that the temporary setting having the margin width is stored in the temporary sheet table 113a (YES in Act 201), the MPU 101 reads the temporary setting (Act 203).

Next, the MPU 101 determines whether or not the margin width of the setting read in the Act 202 or the Act 203 is 4.2 mm (Act 204). If it is determined that the margin width is 4.2 mm (YES in Act 204), the MPU 101 executes print with the margin width of 4.2 mm (Act 205). That is, the MPU 101 causes the image reading unit 5 to read the image from the original document supported by the original document table 5a, sets the margin with 4.2 mm on each of both sides of the sheet in the main-scanning direction, and prints the read image on the sheet.

Then, the MPU 101 determines whether or not a temporary setting having the margin width is stored in the temporary sheet table 113a of the RAM 113 (Act 206). If it is determined that the temporary setting having the margin width is not stored in the temporary sheet table 113a (NO in Act 206), the MPU 101 ends the printing process subroutine.

However, if it is determined that the temporary setting having the margin width is stored in the temporary sheet table 113a (YES in Act 206), the MPU 101 clears the contents of the temporary sheet table 113a, that is, the temporary setting having the margin (Act 207). The MPU 101 then ends the printing process subroutine.

In addition, if it is determined that the margin width is not 4.2 mm in the Act 204 (NO in Act 204), the MPU 101 determines whether the effective writing width D determined based on the first sheet P1 (i.e., a sheet having a maximum size which can be used by the MFP 1), is equal to or larger than a value obtained by subtracting a size of 2.0 mm*2 from the sheet width W of the setting read in the Act 202 or the Act 203 (Act 208). That is, the MPU 101 determines whether or not D≤W−(2.0 mm*2) is satisfied. That is, the MPU 101 determines whether or not the MPU 101 prints the image on the second sheet P2 smaller than the first sheet P1.

If it is determined that D≤W−(2.0 mm*2) is satisfied (YES in Act 208), the MPU 101 executes print with the margin width of 2.0 mm (Act 209). That is, the MPU 101 causes the image reading unit 5 to read the image from the original document supported by the original document table 5a, sets the margin with 2.0 mm on each of both sides of the sheet in the main-scanning direction, and prints the read image on the sheet. Thereafter, the MPU 101 moves the control process to the Act 206.

In addition, if it is determined that D≤W−(2.0 mm*2) is not satisfied in the Act 208 (NO in Act 208), the MPU 101 displays that print with the margin width of 4.2 mm is executed on the display unit 9a of the operation unit 9 via the interface 102 (Act 210). FIG. 10 is a diagram illustrating an example of the display. In this manner, even if the margin width is set to 4.2 mm, the user is notified that print can be performed only at 2.0 mm. After then, the MPU 101 moves the control to the Act 205 and executes print with the margin width of 4.2 mm.

According to the embodiment described above, the MFP 1 in which the margin width can be changed by user operation is obtained.

The above description is an example when the margin change instruction and the print instruction are input from the operation unit 9 to the MPU 101 by the user operation of the operation unit 9, that is, when the MFP 1 is used as a copying apparatus. Even if the margin change instruction and the print instruction are input by the user operation of an external device (e.g., PC, etc.) from the interface 71 to the MPU 101 via the image process unit 73 (i.e., MFP 1 is used as a printing apparatus), the MPU 101 executes the control process in the same manner. That is, “operation unit input process” in FIG. 7 is replaced with “external device input process”, “copy start” is replaced with “print start”, and a display destination of information is set as an external device instead of the display unit 9a, that is, display control information is not output to the display unit 9a by the interface 102 and is output to an external device by the interface 71.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An image forming apparatus, which forms an image on a sheet, comprising:
a memory configured to store a first margin width that is a margin width provided on both sides of a sheet width in a direction orthogonal to a sheet transport direction of the sheet, and in which no image is formed;
an exposure device including a predetermined number of light emitting elements arranged in the direction orthogonal to the sheet transport direction of the sheet on which the image is to be formed;
a controller configured to accept a user setting of the sheet on which the image is to be formed, the sheet on which the image is to be formed including at least a first sheet which is a sheet of maximum size usable by the image forming apparatus and a second sheet different from the first sheet;
accept the user setting of the margin width, wherein the margin width includes the first margin width and a second margin width which is smaller than the first margin width;
determine the margin width which is set based on the user setting or the first margin width stored in the memory as the margin of the sheet that is set by the controller;
control the exposure device according to the determined margin width to form the image on the sheet set by the controller,
wherein the controller is configured to cause the image to be formed such that an effective writing width, which is a width of the image formable on the sheet by the predetermined number of light emitting elements, corresponds to a width obtained by subtracting the first margin width from the sheet width of the first sheet.

2. (canceled)

3. The apparatus according to claim 1,
wherein when the second sheet is set by the controller, the controller determines the margin width set by the controller as the margin that is set for the second sheet.

4. The apparatus according to claim 1,
wherein when the first sheet is set by the controller, the controller determines the first margin width stored in the memory as the margin that is set for the first sheet, regardless of the margin width set by the user setting.

5. The apparatus according to claim 4, further comprising:
a display panel configured to display information for the user,
wherein when the controller determines the first margin width stored in the memory as the margin set for the first sheet, regardless of the margin width set by the user setting, the controller controls the display panel and displays information regarding the image formation on the display panel.

6. The apparatus according to claim 1, wherein:
the memory is configured to store a predetermined margin width for each of the sheets on which the image is to be formed, and
wherein when the margin width is not set by the user setting and the second sheet is set by the user setting, the controller controls the exposure device to perform image formation according to the predetermined margin width stored in the memory.

7. The apparatus according to claim 1, wherein:
when the first margin width is set based on the user setting, the controller is configured to determine the first margin width as the margin set for the first sheet;
when the second margin width is set based on the user setting, the controller is configured to compare an image formation width obtained by subtracting the second margin width from the sheet width of the sheet set by the controller with the effective writing width;
when the image formation width is smaller than the effective writing width, the controller is configured to determine the second margin width set based on the user setting as the margin of the sheet set by the controller; and
when the image formation width is equal to or larger than the effective writing width, the controller is configured to determine the first margin width stored in the memory as the margin of the sheet set by the controller, regardless of the second margin width set based on the user setting.

8. The apparatus according to claim 7, further comprising:
a display panel configured to display information for the user,
wherein when the controller determines the first margin width stored in the memory as the margin of the sheet, regardless of the second margin width set by the user setting, the controller controls the display panel and displays information regarding the image formation on the display panel.

9. The apparatus according to claim 7, wherein the memory is configured to store a predetermined margin width for each of the sheets on which the image is to be formed.

10. An image forming method performed by an image forming apparatus which includes a controller and a memory configured to store a first margin width that is a margin width provided on both sides of a sheet width in a direction orthogonal to a sheet transport direction of a sheet, and in which no image is formed, and an exposure device including a predetermined number of light emitting elements arranged in a linear shape in the direction orthogonal to the sheet transport direction of the sheet on which an image is to be formed, the method comprising:
accepting a user setting of the sheet on which the image is to be formed, the sheet on which the image is to be formed including at least a first sheet which is a sheet of maximum size usable by the image forming apparatus and a second sheet different from the first sheet;
accepting the user setting of a margin width, wherein the margin width includes the first margin width and a second margin width smaller than the first margin width; and
determining the margin width which is set based on the user setting or the first margin width stored in the memory as the margin of the sheet set by the controller;
controlling the exposure device according to the determined margin width to form the image on the sheet set by the controller; and
causing the image to be formed such that an effective writing width, which is a width of the image formable on the sheet by the predetermined number of light emitting elements, corresponds to a width obtained by subtracting the first margin width from the sheet width of the first sheet.

11. (canceled)

12. The method according to claim 10, further comprising:
when the second sheet is set by the controller, determining the margin width set by the controller as the margin set for the second sheet.

13. The method according to claim 10, further comprising:
when the first sheet is set by the controller, determining the first margin width stored in the memory as the margin set for the first sheet, regardless of the margin width set based on the user setting.

14. The method according to claim 13, further comprising:
displaying information for the user by a display panel, and when determining the first margin width stored in the memory as the margin set for the first sheet, regardless of the margin width set based on the user setting, displaying image formation information by the display panel.

15. The method according to claim 10, further comprising:
storing by the memory, a predetermined margin width for each of the sheets on which the image is to be formed, and
when the margin width is not set based on the user setting and the second sheet is set based on the user setting, performing image formation by the exposure device according to the predetermined margin width stored in the memory.

16. The method according to claim 10, further comprising:
when the first margin width is set based on the user setting determining the first margin width as the margin of the first sheet;
when the second margin width is set based on the user setting, comparing an image formation width obtained by subtracting the second margin width from the sheet width of the sheet set by the controller with the effective writing width;
when the image formation width is smaller than the effective writing width, determining the second margin width set based on the user setting as the margin of the sheet set by the controller; and
when the image formation width is equal to or larger than the effective writing width, determining the first margin width stored in the memory as the margin of the sheet set by the controller, regardless of the second margin width set based on the user setting.

17. The method according to claim 16, further comprising:
displaying information for the user by a display panel, and when determining the first margin width set in the memory as the margin of the sheet set the controller, regardless of the second margin width set based on the user setting, displaying image formation information by the display panel.

18. The method according to claim 16, further comprising:
storing by the memory, a predetermined margin width for each of the sheets on which the image is to be formed.
